(19) United States
(12) Patent Application Publication
(10) Pub. No.: US 2017/0039592 A1
(43) Pub. Date: Feb. 9, 2017

(54) ADVERTISEMENT COORDINATION

(71) Applicant: Microsoft Technology Licensing, LLC, Redmond, WA (US)

(72) Inventors: Michael C. Kunz, Seattle, WA (US); David S. Barlin, Seattle, WA (US); Joost Boon, Seattle, WA (US); Brian D. Holdsworth, Woodinville, WA (US); Michael D. Schackwitz, Pleasanton, CA (US)

(21) Appl. No.: 15/295,751

(22) Filed: Oct. 17, 2016

Related U.S. Application Data
(63) Continuation of application No. 12/428,620, filed on Apr. 23, 2009.

(51) Int. Cl. G06Q 30/02; G06K 9/00; H04L 12/58

(52) U.S. Cl. CPC G06Q 30/0255; H04L 51/22; G06Q 30/0277; G06K 9/00469; G06F 3/0482

(57) ABSTRACT

A system is disclosed for serving advertisements to a user of a client device. Based on a user requesting to view an email message in their inbox, the system provides the email message to the user. At least one header field in the header portion of the email message is scanned and data is extracted from at least one header field. The extracted data is delivered to an advertising server, which selects an advertisement that is relevant to the extracted data and delivers the relevant advertisement back to the system. The relevant advertisement is delivered to the user.

### BACKGROUND OF THE TECHNOLOGY

The use of electronic mail (email) has expanded. More and more people are using email for business and personal reasons. One particular form of email that has become more popular is web-based email services. Rather than using a dedicated email client, web-based email services allow a user to access an email inbox using an Internet browser. This allows a user to access email from any computer, without requiring the computer to have an email application installed. Thus, users traveling can access email from any place there is a computer connected to the Internet.

There are a tremendous amount of Internet-based services available to people throughout the world. For example, some web-based email services use advertisements (also referred to as an “ad”) to generate revenue for the email service. In some embodiments, advertisements will be placed in the graphical user interface (GUI) of the email service. In the past, the advertisements were randomly chosen. Recently, at least one email service has been scanning content in the body of the email at the email server in an attempt to identify advertisements relevant to the content of the email. The email messages are stored on an email server. That email server is used to store messages for many users. While the email is at the server, the content of the email will be scanned by the server. The content of the email will then be matched to one or more advertisements. The matching of advertisements is performed at the server. The email messages and the one or more relevant advertisements are subsequently sent to the client browser. While this example provides a means for web-based email services to generate revenue, scanning the content in the body of the email may compromise the privacy of the user.

### SUMMARY OF THE TECHNOLOGY

A system is disclosed for serving advertisements to a user of a client device that maintains the privacy of the user. Based on a user requesting to view an email message in their inbox, the system provides the email message to the user. At least one field in the header of the email message is scanned and data is extracted from at least one header field. The extracted data and sender domain is delivered to an advertising server, which selects an advertisement that is relevant to the extracted data and delivers the relevant advertisement back to the system. The relevant advertisement is delivered to the user. The relevant advertisement is displayed to the user in an advertising window of an email user interface.

One embodiment includes scanning the fields of the message header and extracting a sender domain in the “From:” field. The sender domain is delivered to an ad server, which selects an ad relevant to the sender domain. The ad server then delivers to the ad to the email system, which serves the ad to the user. Any of the fields in the email header may be scanned, and the data from one or more fields may be used to determine which ad is relevant to the extracted data. More than one ad may be determined to be relevant to the extracted data and may be delivered to the email system.

One embodiment includes displaying an email message list via a web-based browser in an inbox format to the user and displaying an advertisement based on the email message selected by the user. Input is received indicating that the user has selected to view an email message displayed in the inbox. An advertisement that is relevant to the selected email message and sender domain is received from an advertising server which, in one embodiment, selected the advertisement based on a sender domain contained in a header field of the email message selected by the user. The advertising server may select an advertisement based on data contained in any field of the email header. The email message selected by the user is render in a user interface having a display window and an advertisement window. The advertisement selected by the advertising server is displayed in the advertisement window.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of one example of a web based email system.

FIG. 2 depicts a block diagram of one example of a computing system.

FIG. 3 depicts a flow chart describing one embodiment of a process performed when viewing an email message.

FIG. 4 depicts a user interface for one embodiment of an email system.

FIG. 5 depicts a flow chart describing one embodiment identifying a relevant advertisement.

FIG. 6 depicts an exemplary header portion associated with an email message.

FIG. 7 depicts a user interface for another embodiment of an email system.

FIG. 8 depicts a flow chart describing another embodiment of a process performed when viewing an email message.

### DETAILED DESCRIPTION

A system is disclosed that serves advertisements to a user. To protect the privacy of the user, the content in the body of the email message is not scanned or used to determine an advertisement that is relevant to the email message. Instead, one or more fields in the email header are scanned to determine which advertisements are relevant to the email message and sender domain and should be served to the user. The ads may be served to a user when the user opens an email message or accesses the inbox (which includes a list of email messages).

One example of an email system is a web-based email service. However, the present technology can apply to other email systems that provide email to non web-based access methods. For example, the technology can be applied to an email service based on an email server and a local LAN or other network (e.g., using a Microsoft Exchange Server or other email server). The technology is not limited to any specific email server or service.

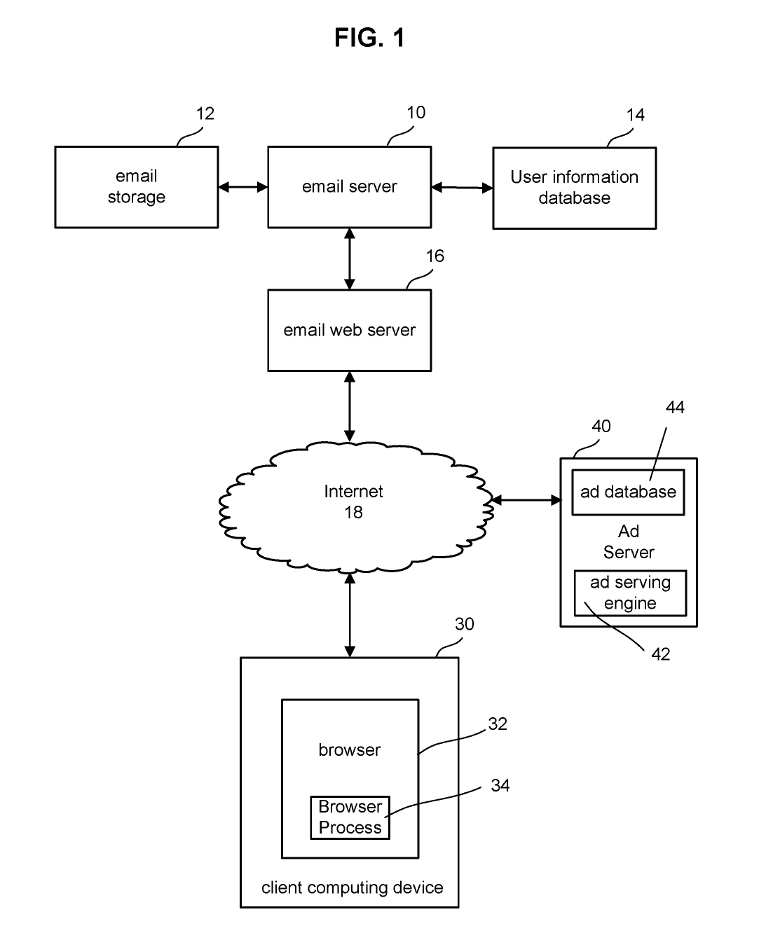

FIG. 1 provides a block diagram of one embodiment of a suitable web-based email system that interacts with a web browser to provide an email service. The system includes an email server 10 that is in communication with email storage system 12, user information database 14, and email web server 16. Email web server 16 is in communication, via Internet 18, with one or more client devices 30. The single client device 30 shown in FIG. 1 is exemplary only, and is not intended to limit the scope of the technology described herein. It is understood that email web server 16 communicates with more than one client device 30. FIG. 1 shows client device 30 utilizing a browser application 32 and browser process 34.

Email server 10 provides the basic functionality of the web-based email system, and will provide email data to web server 16, and send data to and receive data from user information database 14. User information database 14 stores user information. User information can include telephone numbers, email addresses, street addresses, contact lists, instant messaging buddy lists, and other information relevant to a user. Email storage system 12 includes data storage devices that store the content of email messages. Email web server 16 provides the Hypertext Markup Language (HTML) code for providing pages on browser 32 that display and interact with the email system. Thus, email web server 16 serves as the front end of the system that interacts with the browser, while email server 10 provides the core business logic of the email system. More information about a web based system can be found in U.S. patent application Ser. No. 11/028,915, titled “Web Application Architecture,” which is assigned to Microsoft Corporation and is incorporated herein by reference in its entirety.

FIG. 1 also illustrates an ad server 40. Running within or in conjunction with ad server 40 is ad serving engine 42, which is used to selects ads to serve to a user. In one embodiment, ad serving engine 42 is implemented using JavaScript. The ad serving engine 42 selects ads from the ad database 44. An ad server may comprise a server operated by the sender outside of the email system which stores advertisements. An ad server may be a local server maintained by a single sender or a remote third-party server that serves ads across domains owned by multiple senders.

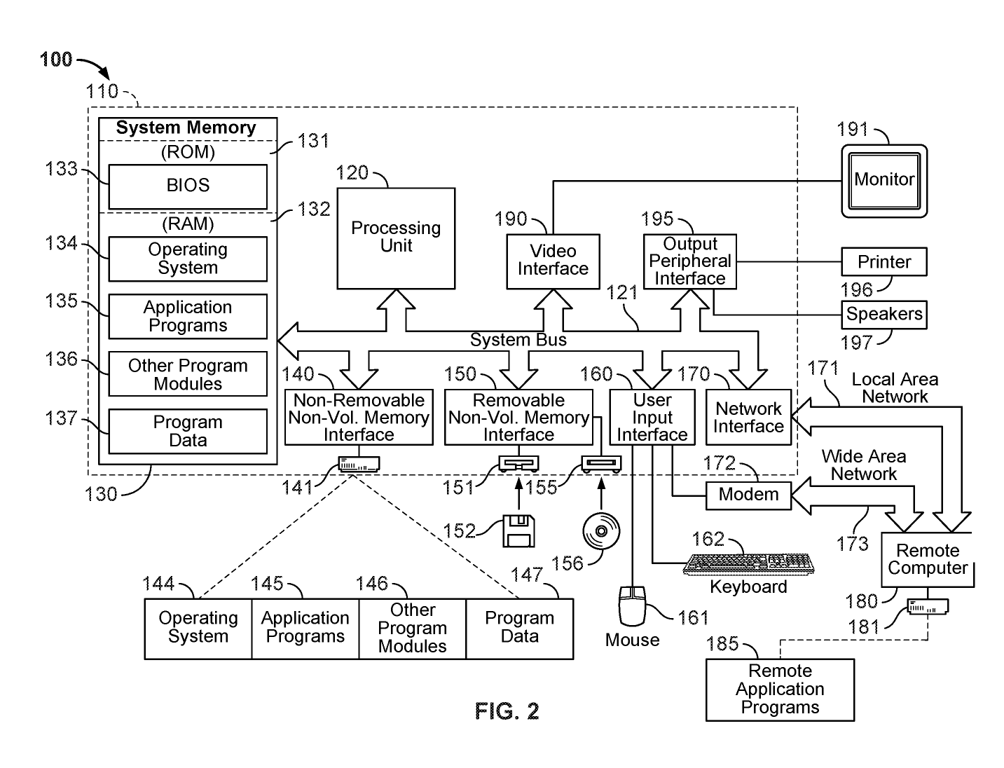

FIG. 2 illustrates an example of a suitable general computing environment that may be used as client computing device 30, email web server 10, email storage 12, user information database 14 or email web server 16. The computing system environment 100 is only one example of a suitable computing environment and is not intended to suggest any limitation as to the scope of use or functionality of the technology. Neither should the computing environment 100 be interpreted as having any dependency or requirement relating to any one or combination of components illustrated in the exemplary operating environment 100.

The technology is operational with numerous other general purpose or special purpose computing system environments or configurations. Examples of well known computing systems, environments, and/or configurations that may be suitable for use with the technology include, but are not limited to, personal computers, server computers, hand-held or laptop devices, personal digital assistants, telephones (wired, wireless, or cellular), multiprocessor systems, microprocessor-based systems, set top boxes, programmable consumer electronics, network PCs, minicomputers, mainframe computers, distributed computing environments that include any of the above systems or devices, and the like.

The technology may be described in the general context of computer-executable instructions, such as program modules, being executed by a computer. Generally, program modules include routines, programs, objects, components, data structures, etc., that perform particular tasks or implement particular abstract data types. The technology may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the technology includes a general purpose computing device in the form of a computer 110.

Components of computer 110 may include, but are not limited to, a processing unit 120 (which can include multiple processors), a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/ nonvolatile computer storage media that can be used in the exemplary operating environment include, but are not limited to, magnetic tape cassettes, flash memory cards, digital versatile disks, digital video tape, solid state

RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172, network interface or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

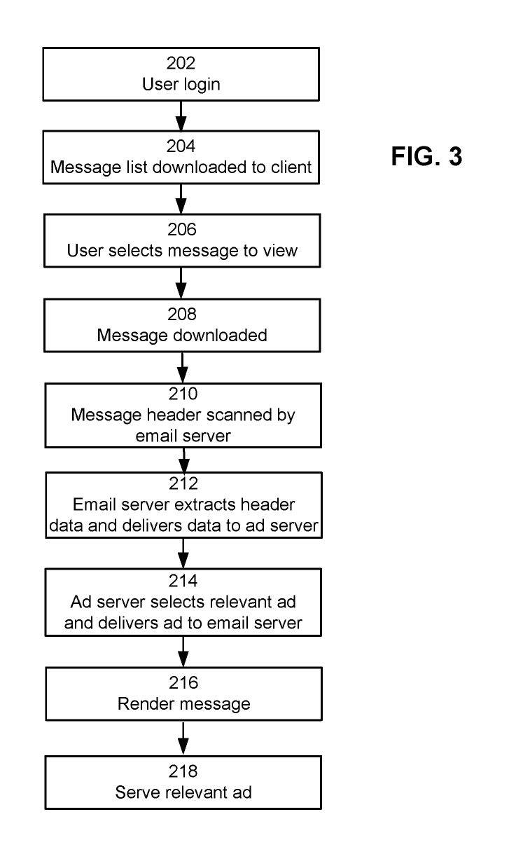

FIG. 3 is a flowchart describing one embodiment of a process that is performed when a user of client computing device 30 logs into a free web-based email service. In step 202, the user logs into the web-based email service. For example, the user will open browser application 32 on client computing device 30 and navigate to the web page for the email service. With a free web-based email service, the user will be prompted to enter a user name and password. After entering that data, the email service will authenticate the user. In some embodiments, the log-in process can be performed automatically or omitted. Additionally, other variations of the log-in process can be used. The user may then navigate to and view their inbox.

After logging on, in step 202, the message list of the user's inbox is downloaded to client device 30, at step 204. This is performed by email server 10 accessing the messages from email storage system 12 that are in the inbox for the user who logged in. In one embodiment, the information accessed by email server 10 includes the “From:” field, “Subject:” field, “Date:” field, “Size:” field, and an indication whether there is an attachment. This information is then provided to email web server 16, which creates an inbox page using HTML or another means. The inbox page is then transmitted from email web server 16 to browser 32.

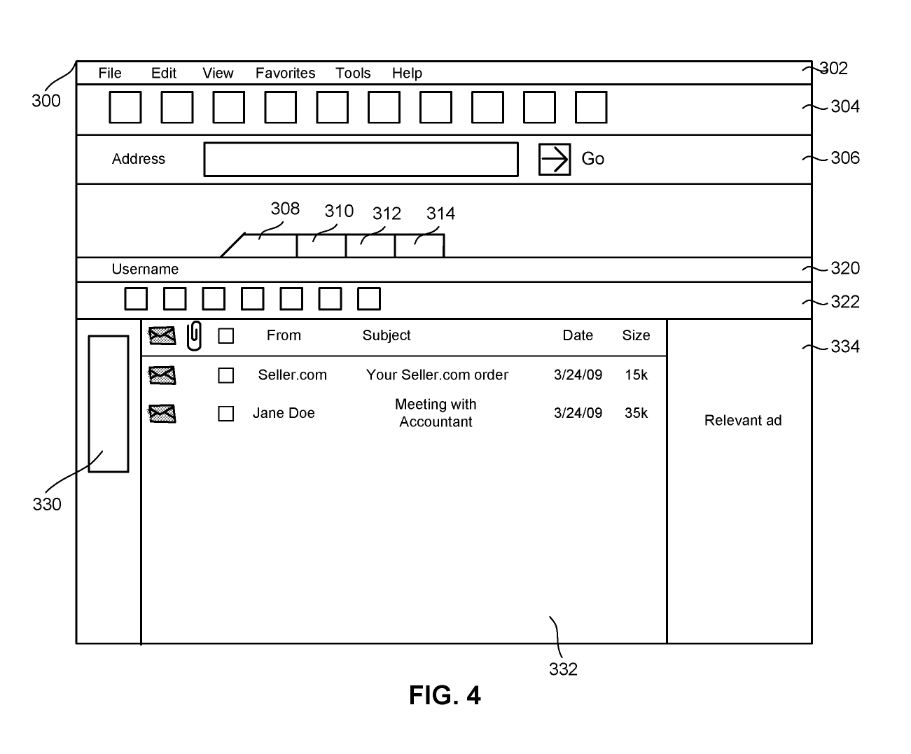

FIG. 4 provides an example of a GUI 300 that would be provided on a monitor or other display device for client computing device 30 at the completion of step 204. Drop-down menus 302 includes a File drop-down menu, Edit drop-down menu, View drop-down menu, Favorites drop-down menu, Tools drop-down menu and Help drop-down menu. Below the drop-down menus 302 are buttons 304, which include buttons for going back, going forward, stopping, reloading, going to a home page, searching, accessing favorites, etc. Below buttons 304 is address field 306 with a Go button. The GUI 300 also includes several tabs 308, 310, 312 and 314 for navigating between a mail service, calendar service, address book and other services. Below the tabs is a field to indicate the user name 320 of the user logged into the email service. Below the user name are a series of buttons 322 to allow the user to create a new email, delete an email, block an email, move an email to a different folder, search or mark an email as being read/unread/important. GUI 300 also includes a set of links 330 for navigating the user to various portions of the email service, including inbox, junk email, sent messages, draft messages and a trash can.

GUI 300 includes inbox 332, which lists the various messages. In one embodiment, the list of messages in inbox 332 corresponds to the message list downloaded in step 204 of FIG. 3. FIG. 4 illustrates that the inbox displays the “From” field, “Subject” field, “Date” field, size of the email, and an indication of whether there is an attachment (paperclip) and indication of whether the mail has been read (open envelope) or unread (closed envelope). In other embodiments, other data can be provided in the inbox.

GUI 300 also includes an ad window 334. In FIG. 4, one ad is displayed in the ad window 334. However, in other embodiments, more than one ad can be displayed in the ad window 334. As will de discussed later in more detail, the ad displayed in the ad window 334 is relevant to an email message. The ad(s) displayed in the ad window 334 may be relevant to the most recent email message displayed in the inbox 332. The ad(s) displayed in the ad window 334 may be relevant to any of the email messages contained in email storage 12.

Other variations of GUI 300 can be used with respect to the present technology. For example, if the technology described herein is being used with a mobile telephone, the display on a mobile telephone would be smaller than a computer and, thus, not all of the elements of GUI 300 will be included. Other embodiments include providing the ads in a means other than displaying it, such as providing the ads using audio data. For example, the ads can be read using text-to-speech technology known in the art. Alternatively, the ads can be in an audio format such as .wav file, .mp3 file, or any other suitable audio format.

When viewing GUI 300, the user can select any of the messages listed in the inbox. In one embodiment, by double-clicking on a message in the inbox, the entire (or a portion of) message is displayed to the user. In some embodiments, a pop-up window will be created and the message will be displayed in the new pop-up window. In other embodiments, the window displaying GUI 300 will remove GUI 300 and replace it with the selected message.

Returning to FIG. 2, at step 206, the user selects a message to view in GUI 300 by single-clicking with a pointing device, double-clicking with a pointing device, or using another means known in the art. For the purpose of describing the technology herein only, the user selects to view the email message received from “seller.com” displayed in the GUI 300. At step 208, the data for the message from seller.com is downloaded. In one embodiment, browser 32 will make a request to email web server 16 for the email message. That request will be forwarded to email server 10, which will get the data from email storage system 12 and provide that data back to email web server 16. Email web server 16 will then create the code for implementing the page displaying the message and communicate that data, via Internet 18, to browser 32.

At step 210, for the email message selected by the user, the email server 10 scans the data contained in the fields of the email header. The term email header may refer to the message header, envelope header, or a combination of both the message header and envelope header. In one embodiment, the fields in the message header are scanned by the email server 10. Alternatively, the fields in the envelope header are scanned by the email server 10. In another embodiment, the fields in both the message header and envelope header are scanned by the email server 10. More detail about scanning the email header is provided later herein.

At step 212, the email server 10 extracts data contained in one or more header fields and delivers the data to the ad server 40. The data delivered to the ad server 40 is dependent on which header was scanned (step 210) and, in particular, which fields within the header were scanned. For the purpose of describing the technology herein only, the “From:” field in the message header is scanned at step 210, and the sender domain is extracted from the “From:” field of the message header, at step 212. The term “sender domain” is used to refer to the fully qualified domain name used in the replay address (e.g., emailmarketing@sender.com). In another embodiment, another header field is scanned and a campaign ID is extracted from the header field. Additional detail of a campaign ID is provided later herein. The sender domain is then delivered to the ad server 40. It is within the scope of the technology to scan and extract data from more than one header field.

At step 214, the ad server 40 selects an advertisement relevant to the sender domain and delivers the relevant advertisement to the email server 10. More detail will be provided later describing embodiments of selecting relevant ads based on the header data. At step 216, the message is rendered in browser 32. At step 218, the advertisement identified as being relevant in step 214 is served to the user by rendering the advertisement in the browser (or another mode of serving the advertisement). The ad is downloaded to client computing device 30 from email web server 16, which receives the ad from email server 10. In one embodiment, the client computing device 30 renders the advertisement. In other embodiments, other components can render or otherwise serve the advertisement.

In one embodiment, ads are provided when a user opens and views a particular email message. In another embodiment, ads are also provided when the email messages are displayed in the user's inbox (ad window 334 in FIG. 4). In other embodiments, ads are displayed at both instances. In another embodiment, ads can be displayed at other times.

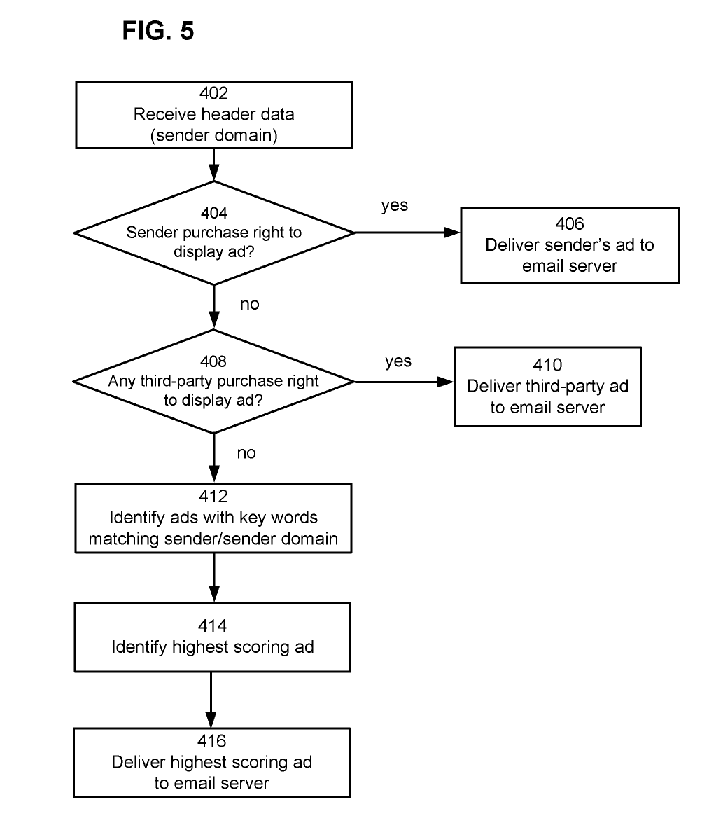

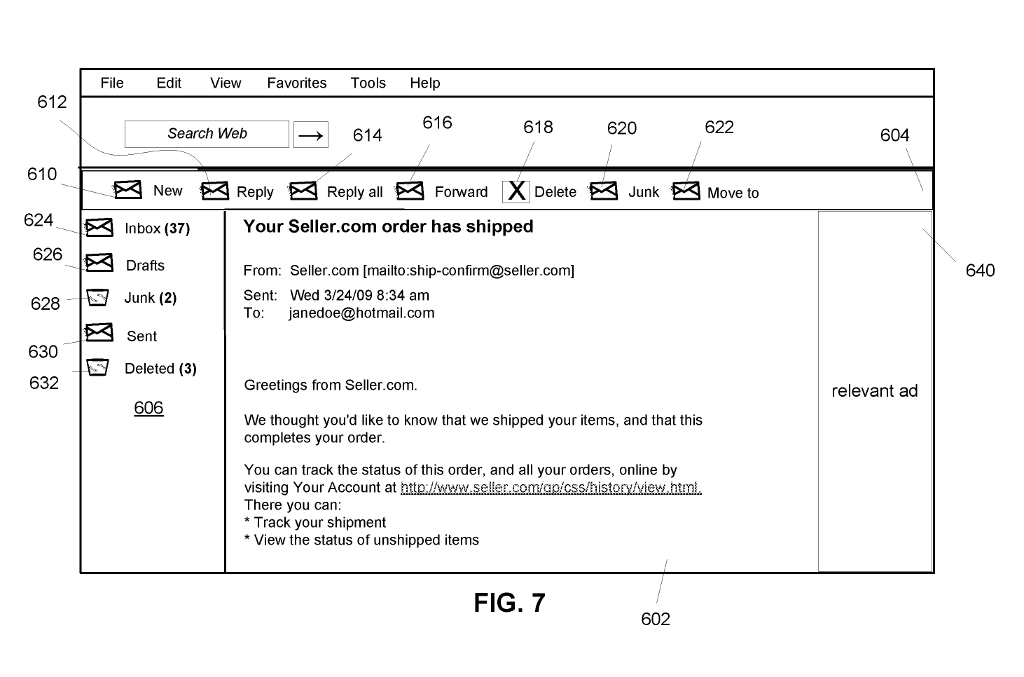

FIG. 5 provides a flow chart illustrating one embodiment of how the ad server 40 may select an advertisement relevant to a sender domain. For the purpose of describing the steps in FIG. 5, the user selected the email message received from seller.com. At step 402, the ad server 40 receives the sender domain seller.com. At step 404, the ad server 40 determines if Seller.com has purchased the right to display ads in the ad window 640 in GUI 600 (see FIG. 7) when an email is sent and their own domain is delivered to the ad server 40. If seller.com has purchased such rights, the ad pool within the ad database 44 available to the ad engine 42 is limited to ads created by seller.com, and the ad pool is recognized as containing the ads relevant to the sender domain. The ad server 40 proceeds to select an Seller.com ad stored in the ad database 44 and delivers the ad to the email server 10, at step 406.

If Seller.com has not purchased this right, the ad server determines if any other third-party has purchased similar rights, at step 408. For example, Barnes &

Noble may be interested in paying for the right to display a Barnes & Noble ad in the ad window 640 of GUI 600 (see FIG. 7) when an Seller.com email message is being displayed in the display window 602. In this instance, the ad pool within the ad database 44 is limited to ads created by Barnes & Noble, and is considered the pool of relevant ads. The ad server 40 selects a Barnes & Noble ad from the ad pool and delivers the ad to the email server 10, at step 410.

If neither Seller.com nor a third-party has purchased such rights, the ad server 40 selects an ad relevant to the sender domain seller.com based on other criteria. FIG. 5 illustrates that one such criteria is key words. At step 412, the ad engine 42 identifies ads with key words matching the sender domain (or sender). At step 414, the highest scoring ad is selected. If more than one ad is to be displayed to the user at a time, the number of ads selected at step 414 correlate with the number of ads that will be displayed. Note that there are many methods for scoring relevance of ads that are known in the art, many of which are used today with respect to search engines. Many of these known schemes can be used. In some embodiments, the relevance can be weighted based on how many words associated with the ad matches the sender domain. Alternatively, certain key words can be weighted higher than other key words. At step 416, the highest scoring ad(s) are delivered to the email server 10.

Other data contained in the email header may be used to determine which ads are relevant to the email message. In some embodiments, the date and IP address associated with the user may be extracted from the email header and delivered to the ad server 40 (step 212). In this instance, the ad engine 42 may determine which ad(s) is relevant to the email message based on the date and IP address. An IP address may help identify a geographical location associated with the user. Thus, the ad engine 42 may use the date and IP address to select an ad for an upcoming sports event that will occur within the geographical location associated with the IP address.

The ad can be chosen by any data contained in a header field of the email message. For example, the email server 10 may scan the message header of the email message and extract all data contained in the header fields (e.g., “From:” field, “Subject:” field, etc.) and deliver the data to the ad server 40. Certain fields in the email header can be weighted higher than others. Relevant ads may be chosen based on other data as well.

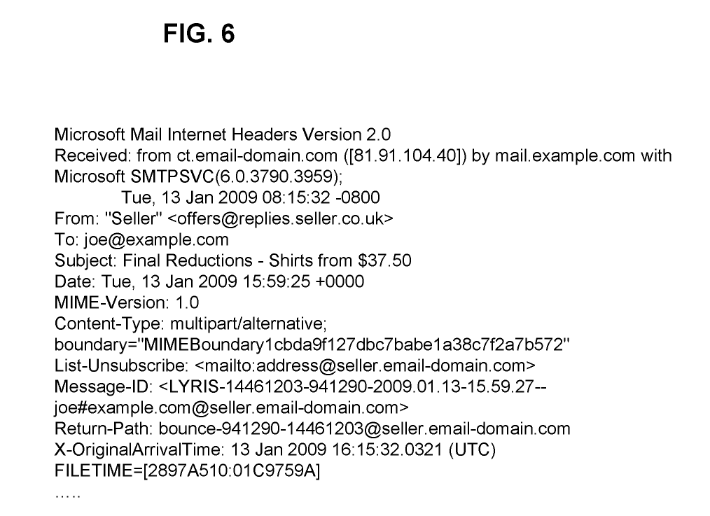

FIG. 6 provides an exemplary header of an email message. As discussed above, in an email message, the text (body) is preceded by header lines indicating sender, recipient, subject, sending time stamp, receiving time stamps of all intermediate and the final mail transfer agent, and much more. These header fields are divided into two headers: a message header and an envelope header. The header fields in an envelope header are not typically visible by a user viewing an email message. On the other hand, header fields in the message header are, and typically include the “From:” field, the “To:” field, the “Subject:” field and the “Date:” field displayed at the top of the email message (see display window 602 in FIG. 7). The basic format of Internet email messages (including headers) is defined in RFC 5322, titled “Internet Message Format.” (October 2008).

FIG. 7 illustrates a GUI 600 that is displayed upon the completion of the steps shown in FIG. 3. The GUI 600 includes a display window 602, toolbar 604 and a folder window 606. The display window 602 is currently displaying the content of the Seller.com email opened by the user. The toolbar 604 includes several icons that a user can select to perform an action. By way of example only, the toolbar includes several buttons that a user can select, including a new message button 610, a reply button 612, a reply all button 614, a forward message button 616, a delete button 618, a junk button 620, a move to button 622, and an unsubscribe or “remove me” button allowing the customer to stop receiving emails from a specific sender in the future. A toolbar is known in the art and therefore, does not require further disclosure herein. The folder window 606 displays an inbox folder 624, a drafts folder 626, a junk folder 628, a sent folder 630 and a deleted folder 632.

FIG. 7 illustrates that the GUI 600 also includes an advertisement window 640 for displaying a relevant ad. Displaying a single relevant ad in the ad window 640 is for exemplary purposes only, and is not intended to limit the scope of the technology described herein. The ad window 640 may display more than one ad. In addition, the ad window 640 is not limited to the location shown in FIG. 7. In one embodiment, the ad window 640 is located to the left of the display window 602. Alternatively, the ad window 640 may be located above the display window 602. Furthermore, the GUI 600 may include more than one ad window 640.

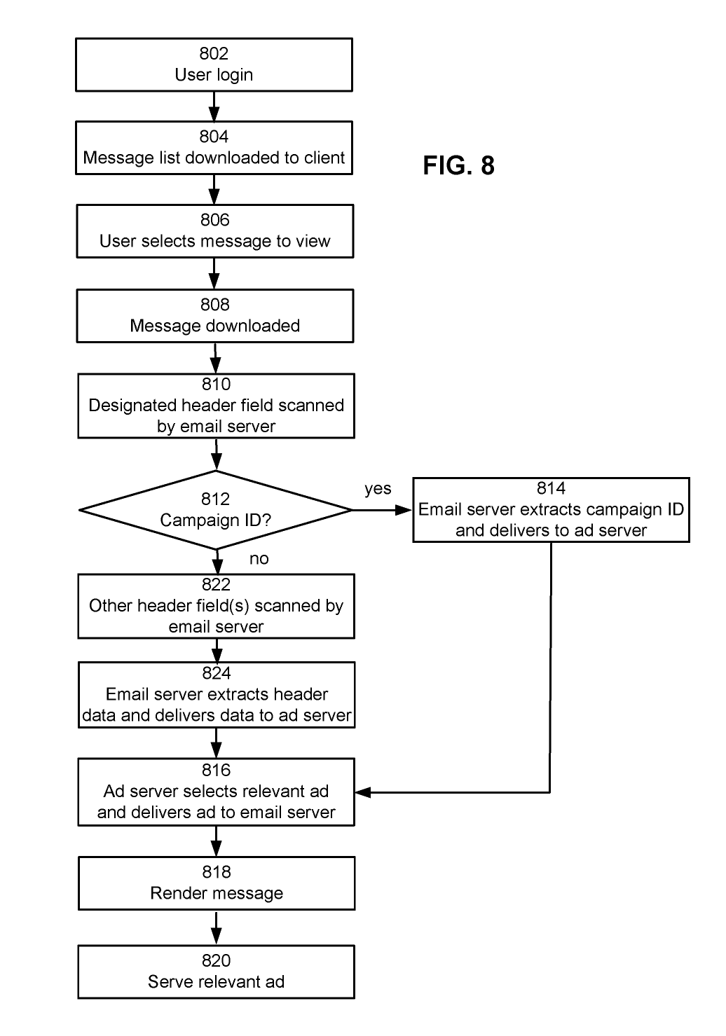

It is also within the scope of the technology for a sender to add a tag in a field of an email header that will cause the ad server 40 to select a specific ad (step 214) and deliver the ad to the email system. FIG. 8 illustrates an alternative embodiment whereby a tag, such as a campaign ID, is added in the email header. A campaign ID is a unique identifier that correlates with a single ad stored in the ad database 44. The campaign ID may be added to any field in the email header. In some embodiments, the sender of the email message would add the campaign ID in a certain field of the email header (e.g., “From:” field of the message header) at the direction of an administrator of the email system. However, it is within the scope of the technology for the sender to add a campaign ID in any field of the email header. One example of technology using a campaign ID to display media content is disclosed in U.S. Application No. ______, Attorney Docket No. MSFT-1279US0, titled “Late Loading Rich Media,” filed ______ 2009, inventors Mike Kunz, Joost Bon, David Barlin, Mike

Schackwitz, Brian Holdsworth, which is assigned to Microsoft Corporation, and is specifically incorporated by reference herein in its entirety.

A campaign ID provides a sender the ability to ensure that a certain ad for display in, for example, ad window 634 in GUI 600, when a user views the email message that contains the campaign ID. For example, a sender may create an email message about an end of year members-only sale intended for delivery to its members. By adding a campaign ID in a header field (whether it is placed in a designated header field or any header field) of the email message, the email system will serve the ad that correlates with a specific ad for the members-only sale in the ad window 634 as the user views the email message.

At step 802, the user logs into the web-based email service. After logging on, in step 802, the message list of the user's inbox is downloaded to client device 30, at step 804. At step 806, the user selects the members-only sale email to view (e.g., that is displayed in GUI 300). At step 808, the data for the members-only message is downloaded.

At step 810, email server 10 scans the header field designated for adding a campaign ID. If a campaign ID is identified in the designated header field (step 812), the email server extracts the campaign ID and delivers the campaign ID to the ad server 40, at step 814. At step 816, the ad sever 40 selects the ad that correlates with the campaign ID and delivers the ad to the email server. At step 818, the message is rendered in browser 32. At step 820, the advertisement is served to the user by rendering the advertisement in the browser (or another mode of serving the advertisement). In one embodiment, the client computing device 30 renders the advertisement. In other embodiments, other components can render or otherwise serve the advertisement.

If the designated header field does not contain a campaign ID (step 812), one or more of the other header fields (other than the designated header field) is scanned by the email server 10, at step 822. As discussed above, any field within the message header and envelope header may be scanned at step 822. At step 824, the email server extracts data from one or more header fields and delivers the data to the ad server 40. At step 816, the ad server 40 selects an advertisement relevant to the extracted data and delivers the relevant advertisement to the email server 10. At step 818, the message is rendered in browser 32. At step 820, the advertisement is served to the user by rendering the advertisement in the browser (or another mode of serving the advertisement).

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1.-29. (canceled)

30. A method for providing advertisements, comprising: providing an email message to a user, the email message having a header containing a plurality of header fields and a body containing content; scanning at least one of the plurality of header fields in the header of the email message; extracting data from at least one of the plurality of header fields in the header of the email message; delivering the extracted data to an advertising server, the advertising server configured to associate at least one advertisement with the extracted data; receiving at least one advertisement associated with the extracted data, the at least one advertisement received from the advertising server; and delivering the at least one advertisement associated with the extracted data to the user.

31. The method as recited in claim 30, wherein the step of scanning at least one of the plurality of header fields in the header of the email message comprises the step of: scanning at least one of the following header fields in the header of the email message: a “From:” field; a “Subject:” field; a “Date:” field; a “To:” field; and a “Reply-to:” field.

32. The method as recited in claim 31, wherein the step of extracting data from at least one of the plurality of header fields in the header of the email message comprises the step of: extracting a sender domain from the “From:” field in the header of the email message.

33. The method as recited in claim 30, wherein the step of extracting data from at least one of the plurality of header fields in the header of the email message comprises the step of: extracting a campaign ID from a header field in the header of the email message.

34. The method as recited in claim 33, wherein the step of receiving at least one advertisement associated with the extracted data comprises the step of: receiving the advertisement that correlates with the campaign ID.

35. The method as recited in claim 30, wherein the step of delivering the at least one advertisement associated with the extracted data to the user comprises the step of: delivering the at least one advertisement associated with the extracted data to the user's client computing device.

36. The method as recited in claim 30, wherein the step of scanning at least one of the plurality of header fields in the header of the email message comprises the step of: scanning the header fields located in a message header of the email message.

37. The method as recited in claim 30, wherein the step of scanning at least one of the plurality of header fields in the header of the email message comprises the step of: scanning the header fields located in an envelope header of the email message.

38. The method as recited in claim 30, wherein the step of scanning at least one of the plurality of header fields in the header of the email message comprises the step of: scanning the header fields located in a message header and an envelope header of the email message.

39. The method as recited in claim 30, further comprising the step of: determining the number of advertisements that will be simultaneously displayed to the user.

40. The method as recited in claim 39, wherein the step of receiving at least one advertisement associated with the extracted data comprises the step of: receiving a number of advertisements each associated with the extracted data equal to the number of advertisements that will be displayed simultaneously to the user.

41. A method for providing advertisements, comprising: providing an email message to a user, the email message having a message header containing a plurality of header fields and a body containing content; scanning at least one of the plurality of header fields in the message header of the email message; extracting a sender domain from at least one of the plurality of header fields in the message header of the email message; delivering the sender domain to an advertising server, the advertising server configured to associate at least one advertisement with the sender domain; receiving an advertisement associated with the sender domain, the advertisement received from the advertising server; and delivering the advertisement to the user.

42. The method as recited in claim 41, wherein the step of providing an email message to a user comprises the steps of: providing an email message list to the user via a web-based browser, the email message list including a plurality of email messages being displayed to the user in an inbox; receiving input from the user indicating that the user has selected to view one of the plurality of email message displayed in the inbox; and providing the selected email message to the user.

43. The method as recited in claim 41, wherein the step of scanning at least one of the plurality of header fields in the message header of the email message comprises the step of: scanning a “From:” field in the message header of the email message.

44. The method as recited in claim 41, wherein the step of scanning at least one of the plurality of header fields in the message header of the email message comprises the step of: scanning a “Subject:” field in the message header of the email message.

45. The method as recited in claim 43, where the step of extracting a sender domain from at least one of the plurality of header fields in the message header of the email message comprises the step of: extracting the sender domain from the “From:” field of the message header.

46. A method for providing advertisements, comprising: displaying an email message list via a web-based browser in an inbox format to the user, the email message list including a plurality of email messages; receiving input from the user indicating that the user has selected to view one of the plurality of email message displayed in the inbox; receiving an advertisement associated with the selected email message, the advertisement is received from an advertising server that selected the advertisement based on a sender domain contained in a header field of the email message selected by the user; rendering the email message selected by the user in a user interface, the user interface having a display window and an advertisement window; and rendering the advertisement in the advertisement window of the user interface.

47. The method as recited in claim 46, further comprising the steps of: receiving input from the user indicating that the user has selected to view a second email message displayed in the inbox; receiving an advertisement associated with the second email message, the advertisement received from an advertising server that selected the advertisement based on a sender domain contained in a header field of the second email message selected by the user; rendering the second email message to the user in a user interface, the user interface having a display window and an advertisement window; and rendering the advertisement in the advertisement window of the user interface.

48. The method as recited in claim 46, wherein the header field containing the sender domain comprises a header field in a message header of the email message.

49. The method as recited in claim 46, further comprising the steps of: receiving input from the user indicating that the user has selected to view a second email message displayed in the inbox; receiving an advertisement associated with the second email message, the advertisement received from an advertising server that selected the advertisement based on a campaign ID contained in a header field of the second email message selected by the user; rendering the second email message to the user in a user interface, the user interface having a display window and an advertisement window; and rendering the advertisement in the advertisement window of the user interface.
